(19) United States
(12) Patent Application Publication
(10) Pub. No.: US 2009/0104453 A1
(43) Pub. Date: Apr. 23, 2009

(54) HEAT-ACTIVABLE POLYURETHANE SHEET

(75) Inventors: Andre Burghardt, Dickesbach (DE); Oliver Hartz, Limburgerhof (DE); Karl-Heinz Schumacher, Neustadt (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/298,771

(22) PCT Filed: May 4, 2007
(86) PCT No.: PCT/EP2007/054339

§ 371 Date: Oct. 28, 2008

(30) Foreign Application Priority Data
May 9, 2006 (EP) 06113655.2

(51) Int. Cl. B32B 27/40

(52) U.S. Cl. 428/423.3; 156/307.1; 156/275.5

(57) ABSTRACT

The use of a film for adhesively bonding two substrates, wherein the film comprises a layer which is composed of more than 30% by weight of a heat-activatable polyurethane (PU layer for short).

The invention relates to the use of a film for adhesively bonding two substrates, wherein the film comprises a layer which is composed of more than 30% by weight of a heat-activatable polyurethane (PU layer for short).

In the automobile and furniture industries moldings are frequently laminated to another laminate, such as to a polymeric film. In such operations the molding and/or the film to be laminated on is/are coated with an adhesive and the two parts are subsequently bonded to one another, generally with application of superatmospheric pressure or under reduced pressure in a thermoforming operation.

DE-A 100 00 656, DE-A 100 01 777, DE-A 103 30 748 or EP-A 1 598 382 disclose heat-activatable polyurethanes. These are polyurethane adhesives comprising carbodiimides. The polyurethane adhesives described already have the advantageous feature that the laminating film can be coated not at the premises of the manufacturer of the laminated molding but instead at the premises of the manufacturer of the laminating film. The resultant film, coated with polyurethane adhesive, can be trans-ported in roll form and stored at the premises of the user. Then, for lamination, the blocking-resistant coating of the polyurethane adhesive is activated by heat—that is, it becomes tacky, and the laminating operation can be carried out.

For different moldings and applications, the manufacturer of the laminated molding generally requires different laminating films; furthermore, in operational facilities of this kind, there is generally a need not only for the adhesive-coated films but also for uncoated films. The manufacturer must therefore stock a multiplicity of coated and uncoated films in order to be able to implement his or her processes at any time. The desire is therefore for a further simplification of the method, in particular a simplification which affects the extent of stock-keeping.

It was an object of the present invention, therefore, to provide a simple method of laminating moldings, it being intended in particular that the laminated moldings should have good performance properties, one example of such a property being very high adhesion of the laminating film to the molding.

Accordingly the use defined at the outset has been found. Also found have been films which are suitable for the method.

The film that is used comprises a layer which is composed of more than 30% by weight of a heat-activatable polyurethane (PU layer for short).

### The Polyurethane

The PU layer comprises as essential constituent a heat-activatable polyurethane, which may also comprise a mixture of different heat-activatable polyurethanes, as a binder.

A suitable polyurethane is preferably one synthesized predominantly from polyisocyanates, especially diisocyanates, and, as reaction partners, polyesterdiols, polyetherdiols or mixtures thereof.

The polyurethane is preferably synthesized from at least 40%, more preferably at least 60%, and very preferably at least 80%, by weight of diisocyanates, polyetherdiols and/or polyesterdiols.

With preference the polyurethane comprises polyesterdiols in an amount of more than 10%, more preferably greater than 30%, in particular greater than 40% or greater than 50%, with very particular preference greater than 60%, by weight based on the polyurethane.

In particular, polyesterdiols are used as synthesis components; if polyesterdiols are used in a mixture with polyetherdiols, preferably at least 50 mol %, more preferably at least 80 mol %, and very preferably 100 mol % of the mixture of polyesterdiols and polyetherdiols is accounted for by polyesterdiols.

The polyurethane preferably has a melting point greater than 30° C., in particular greater than 40° C., more preferably greater than 50° C., or else greater than 60° C., or greater than 70° C.; in general the melting point is not greater than 150° C., in particular not greater than 10° C. The melting point is therefore situated in particular in a range from 30 to 150° C., more preferably from 40 to 150, and very preferably from 30 to 100° C. and in particular from 50 to 80° C.

The polyurethane preferably has a melting enthalpy of more than 20 J/g.

The measurement of the melting point and of the melting enthalpy takes place in this case by the method of differential scanning calorimetry.

The measurement takes place on polyurethane films 200 μm thick which prior to the measurement have been dried in a forced-air drying oven at 40° C. for 72 hours. In preparation for the measurement approximately 13 mg of the polyurethane are introduced into pans. The pans are sealed and the samples are heated to 120° C., cooled at 20 K/min and held at 20° C. for 20 hours. The samples thus prepared are measured by the DSC method in accordance with DIN 53765, the sample being heated at 20 K/min. The temperature evaluated as the melting temperature is the peak temperature in accordance with DIN 53765; the melting enthalpy is determined as in diagram 4 of DIN 53765.

Overall the polyurethane is preferably synthesized from
a) diisocyanates,
b) diols of which
   b1) 10 to 100 mol %, based on the total amount of diols (b), have a molecular weight of 500 to 5000 g/mol,
   b2) 0 to 90 mol %, based on the total amount of diols (b), have a molecular weight of 60 to 500 g/mol,
c) non-(a) and non-(b) monomers containing at least one isocyanate group or at least one group reactive toward isocyanate groups, and further carrying at least one hydrophilic or potentially hydrophilic group to make the polyurethanes dispersible in water,
d) if appropriate, further, non-(a) to non-(c) polyfunctional compounds containing reactive groups which are alcoholic hydroxyl groups, primary or secondary amino groups or isocyanate groups, and
e) if appropriate, non-(a) to non-(d) monofunctional compounds containing a reactive group which is an alcoholic hydroxyl group, a primary or secondary amino group or an isocyanate group.

Particular mention may be made as monomers (a) of diisocyanates X(NCO)₂, where X is an aliphatic hydrocarbon radical having 4 to 15 carbon atoms, a cycloaliphatic or aromatic hydrocarbon radical having 6 to 15 carbon atoms, or an araliphatic hydrocarbon radical having 7 to 15 carbon atoms. Examples of such diisocyanates include tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)-propane, trimethylhexane diisocyanate, 1,4-diisocyanatobenzene, 2,4-diisocyanatotoluene, 2,6-diisocyanatotoluene, 4,4′-diisocyanato-diphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis, and the cis/trans isomers, and mixtures of these compounds. Diisocyanates of this kind are available commercially.

Particularly important mixtures of these isocyanates are the mixtures of the respective structural isomers of diisocyanatotoluene and diisocyanatodiphenylmethane; the mixture of 80 mol % 2,4-diisocyanatotoluene and 20 mol % 2,6-diisocyanatotoluene is particularly suitable. Also of particular advantage are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, in which case the preferred mixing ratio of the aliphatic to the aromatic isocyanates is from 4:1 to 1:4.

Compounds used to synthesize the polyurethanes, in addition to those mentioned above, also include isocyanates which in addition to the free isocyanate groups carry further, blocked isocyanate groups, e.g., uretdione groups.

With a view to effective film-forming and elasticity suitable diols (b) are principally relatively high molecular weight diols (b1), having a molecular weight of from about 500 to 5000, preferably from about 1000 to 3000 g/mol. The molecular weight in question is the number-average molar weight Mn. Mn is obtained by determining the number of end groups (OH number).

The diols (b1) may be polyesterpolyols, which are known, for example, from Ullmanns Encyklopädie der technischen Chemie, 4th edition, volume 19, pp. 62 to 65. It is preferred to use polyesterpolyols which are obtained by reacting dihydric alcohols with dibasic carboxylic acids. Instead of the free polycarboxylic acids it is also possible to use the corresponding polycarboxylic anhydrides or corresponding polycarboxylic esters of lower alcohols or mixtures thereof to prepare the polyesterpolyols. The polycarboxylic acids can be aliphatic, cycloaliphatic, araliphatic, aromatic or heterocyclic and can if appropriate be substituted, by halogen atoms for example, and/or unsaturated. Examples thereof include the following: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, and dimeric fatty acids. Preferred dicarboxylic acids are those of the general formula HOOC—(CH₂)y-COOH, where y is a number from 1 to 20, preferably an even number from 2 to 20, examples being succinic acid, adipic acid, sebacic acid, and dodecanedicarboxylic acid.

Examples of suitable polyhydric alcohols include ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)-cyclohexane, 2-methylpropane-1,3-diol, methylpentanediols, and also diethylene glycol, triethylene glycol, tetraethylene glycol, polyethylene glycol, dipropylene glycol, polypropylene glycol, and dibutylene glycol and polybutylene glycols. Preferred alcohols are those of the general formula HO—(CH₂)x-OH, where x is a number from 1 to 20, preferably an even number from 2 to 20. Examples of such alcohols include ethylene glycol, butane-1,4-diol, hexane-1,6-diol, octane-1,8-diol, and dodecane-1,12-diol. Preference is also given to neopentyl glycol.

Suitability is also possessed if appropriate by polycarbonatediols, such as may be obtained, for example, by reacting phosgene with an excess of the low molecular weight alcohols specified as synthesis components for the polyesterpolyols.

It is also possible, if appropriate, to use lactone-based polyesterdiols, which are homopolymers or copolymers of lactones, preferably hydroxy-terminated adducts of lactones with suitable difunctional starter molecules. Preferred lactones are those derived from compounds of the general formula HO—(CH₂)z-COOH where z is a number from 1 to 20 and where one hydrogen atom of a methylene unit may also be substituted by a C1 to C4 alkyl radical. Examples are e-caprolactone, β-propiolactone, g-butyrolactone and/or methyl-e-caprolactone, and mixtures thereof. Examples of suitable starter components are the low molecular weight dihydric alcohols specified above as a synthesis component for the polyesterpolyols. The corresponding polymers of e-caprolactone are particularly preferred. Lower polyesterdiols or polyetherdiols as well can be used as starters for preparing the lactone polymers. Instead of the polymers of lactones it is also possible to use the corresponding chemically equivalent polycondensates of the hydroxycarboxylic acids corresponding to the lactones.

Polyetherdiols are obtainable in particular by polymerizing ethylene oxide, propylene oxide, butylene oxide, tetrahydrofuran, styrene oxide or epichlorohydrin with itself, in the presence of BF3 for example, or by subjecting these compounds, if appropriate in a mixture or in succession, to addition reaction with starter components containing reactive hydrogen atoms, such as alcohols or amines, examples being water, ethylene glycol, propane-1,2-diol, propane-1,3-diol, 2,2-bis(4-hydroxyphenyl)propane, and aniline. Particular preference is given to polypropylene oxide, polytetrahydrofuran with a molecular weight of from 240 to 5000, and in particular of from 500 to 4500.

Compounds subsumed under b1) include only those polyetherdiols composed to an extent of less than 20% by weight of ethylene oxide. Polyetherdiols with at least 20% by weight are hydrophilic polyetherdiols, which are counted as monomers c).

It is also possible, if appropriate, to use polyhydroxyolefins, preferably those having 2 terminal hydroxyl groups, e.g., α,ω-dihydroxypolybutadiene, α,ω-dihydroxypolymethacrylic esters or α,ω-dihydroxypolyacrylic esters, as monomers (c1). Such compounds are known for example from EP-A 622 378. Further suitable polyols are polyacetals, polysiloxanes, and alkyd resins.

Preferably at least 30 mol %, in particular at least 70 mol %, of the diols b1) are polyesterdiols. With particular preference polyesterdiols exclusively are used as diols b1).

The hardness and the elasticity modulus of the polyurethanes can be increased by using as diols (b) not only the diols (b1) but also low molecular weight diols (b2) having a molecular weight of from about 60 to 500, preferably from 62 to 200 g/mol.

Monomers (b2) used are in particular the synthesis components of the short-chain alkanediols specified for preparing polyesterpolyols, preference being given to unbranched diols having 2 to 12 C atoms and an even number of C atoms, and also to pentane-1,5-diol and neopentyl glycol.

Examples of suitable diols b2) include ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, additionally diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)x-OH, where x is a number from 1 to 20, preferably an even number from 2 to 20. Examples thereof are ethylene glycol, butane-1,4-diol, hexane-1,6-diol, octane-1,8-diol, and dodecane-1,12-diol. Preference is further given to neopentyl glycol.

The fraction of diols (b1), based on the total amount of diols (b), is preferably from 10 to 100 mol %, and the fraction of the monomers (b2), based on the total amount of diols (b), is preferably from 0 to 90 mol %. With particular preference the ratio of the diols (b1) to the monomers (b2) is from 0.1:1 to 5:1, more preferably from 0.2:1 to 2:1.

In order to make the polyurethanes dispersible in water they comprise as synthesis component preferably non-(a), non-(b), and non-(d) monomers (c) which carry at least one isocyanate group or at least one group reactive toward isocyanate groups and, furthermore, at least one hydrophilic group or a group which can be converted into a hydrophilic group. In the text below, the term “hydrophilic groups or potentially hydrophilic groups” is abbreviated to “(potentially) hydrophilic groups”. The (potentially) hydrophilic groups react with isocyanates at a substantially slower rate than do the functional groups of the monomers used to synthesize the polymer main chain.

The fraction of the components having (potentially) hydrophilic groups among the total quantity of components (a), (b), (c), (d), and (e) is generally such that the molar amount of the (potentially) hydrophilic groups, based on the amount by weight of all monomers (a) to (e), is from 30 to 1000, preferably from 50 to 500, and more preferably from 80 to 300 mmol/kg.

The (potentially) hydrophilic groups can be nonionic or, preferably, (potentially) ionic hydrophilic groups.

Particularly suitable nonionic hydrophilic groups are polyethylene glycol ethers composed of preferably from 5 to 100, more preferably from 10 to 80 repeating ethylene oxide units. The amount of polyethylene oxide units is generally from 0 to 10% by weight, preferably from 0 to 6% by weight, based on the amount by weight of all monomers (a) to (e).

Preferred monomers containing nonionic hydrophilic groups are polyethylene oxide diols containing at least 20% by weight of ethylene oxide, polyethylene oxide monools, and the reaction products of a polyethylene glycol and a diisocyanate which carry a terminally etherified polyethylene glycol radical. Diisocyanates of this kind and processes for preparing them are specified in U.S. Pat. No. 3,905,929 and U.S. Pat. No. 3,920,598.

Ionic hydrophilic groups are, in particular, anionic groups such as the sulfonate, the carboxylate, and the phosphate group in the form of their alkali metal salts or ammonium salts, and also cationic groups such as ammonium groups, especially protonated tertiary amino groups or quaternary ammonium groups.

Potentially ionic hydrophilic groups are, in particular, those which can be converted into the abovementioned ionic hydrophilic groups by simple neutralization, hydrolysis or quaternization reactions, in other words, for example, carboxylic acid groups or tertiary amino groups.

(Potentially) ionic monomers (c) are described at length in, for example, Ullmanns Encyklopädie der technischen Chemie, 4th edition, volume 19, pp. 311-313 and in, for example, DE-A 1 495 745.

Of particular practical importance as (potentially) cationic monomers (c) are, in particular, monomers containing tertiary amino groups, examples being tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines, and N-aminoalkyldialkylamines, the alkyl radicals and alkanediyl units of these tertiary amines consisting independently of one another of 1 to 6 carbon atoms. Also suitable are polyethers containing tertiary nitrogen atoms and preferably two terminal hydroxyl groups, such as are obtainable in a conventional manner, for example, by alkoxylating amines containing two hydrogen atoms attached to amine nitrogen, such as methylamine, aniline or N,N′-dimethylhydrazine. Polyethers of this kind generally have a molar weight of between 500 and 6000 g/mol.

These tertiary amines are converted into the ammonium salts either with acids, preferably strong mineral acids such as phosphoric acid, sulfuric acid, hydrohalic acids, or strong organic acids, or by reaction with suitable quaternizing agents such as C1 to C6 alkyl halides or benzyl halides, e.g., bromides or chlorides.

Suitable monomers having (potentially) anionic groups normally include aliphatic, cycloaliphatic, araliphatic or aromatic carboxylic acids and sulfonic acids which carry at least one alcoholic hydroxyl group or at least one primary or secondary amino group. Preference is given to dihydroxyalkylcarboxylic acids, especially those having 3 to 10 carbon atoms, such as are also described in U.S. Pat. No. 3,412,054. Particular preference is given to compounds of the general formula (c₁)

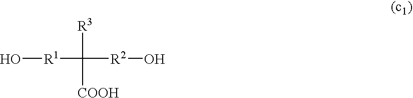

in which R1 and R2 are a C1 to C4alkanediyl (unit) and R3 is a C1 to C4 alkyl (unit), and especially dimethylolpropionic acid (DMPA).

Also suitable are corresponding dihydroxysulfonic acids and dihydroxyphosphonic acids such as 2,3-dihydroxypropanephosphonic acid.

Otherwise suitable are dihydroxyl compounds having a molecular weight of more than 500 to 10 000 g/mol and at least 2 carboxylate groups, which are known from DE-A 39 11 827. They are obtainable by reacting dihydroxyl compounds with tetracarboxylic dianhydrides such as pyromellitic dianhydride or cyclopentanetetracarboxylic dianhydride in a molar ratio of from 2:1 to 1.05:1 in a polyaddition reaction. Particularly suitable dihydroxyl compounds are the monomers (b2) cited as chain extenders and also the diols (b1).

Suitable monomers (c) containing amino groups reactive toward isocyanates include aminocarboxylic acids such as lysine, β-alanine or the adducts of aliphatic diprimary diamines with α,β-unsaturated carboxylic or sulfonic acids that are specified in DE-A 20 34 479.

Such compounds obey, for example, the formula (c2)

H2N—R4-NH—R5-X (c2)

where
R4 and R5 independently of one another are a C1 to C6 alkanediyl unit, preferably ethylene

### and X is COOH or SO₃H.

Particularly preferred compounds of the formula (c₂) are N-(2-aminoethyl)-2-aminoethanecarboxylic acid and also N-(2-aminoethyl)-2-aminoethanesulfonic acid and the corresponding alkali metal salts, with Na being a particularly preferred counterion.

Also particularly preferred are the adducts of the abovementioned aliphatic diprimary diamines with 2-acrylamido-2-methylpropanesulfonic acid, as described for example in DE-B 1 954 090.

Where monomers with potentially ionic groups are used their conversion into the ionic form may take place before, during or, preferably, after the isocyanate polyaddition, since the ionic monomers are frequently difficult to dissolve in the reaction mixture. Neutralizing agents are, for example, ammonia, NaOH, triethanolamine (TEA), triisopropylamine (TIPA) or morpholine, and/or its derivatives. With particular preference, the sulfonate or carboxylate groups are in the form of their salts with an alkali metal ion or an ammonium ion as counterion.

The monomers (d), which are different from the monomers (a) to (c) and which if appropriate also are part of the polyurethane, serve generally for crosslinking or chain extension. They generally comprise nonphenolic alcohols with a functionality of more than 2, amines having 2 or more primary and/or secondary amino groups, and compounds which as well as one or more alcoholic hydroxyl groups carry one or more primary and/or secondary amino groups.

Alcohols having a functionality of more than 2, which may be used in order to set a certain degree of branching or crosslinking, include for example trimethylolpropane, glycerol, or sugars.

Also suitable are monoalcohols which as well as the hydroxyl group carry a further isocyanate-reactive group, such as monoalcohols having one or more primary and/or secondary amino groups, monoethanolamine for example.

Polyamines having 2 or more primary and/or secondary amino groups are used especially when the chain extension and/or crosslinking is to take place in the presence of water, since amines generally react more quickly than alcohols or water with isocyanates. This is frequently necessary when the desire is for aqueous dispersions of crosslinked polyurethanes or polyurethanes having a high molar weight. In such cases the approach taken is to prepare prepolymers with isocyanate groups, to disperse them rapidly in water, and then to subject them to chain extension or crosslinking by adding compounds having two or more isocyanate-reactive amino groups.

Amines suitable for this purpose are generally polyfunctional amines of the molar weight range from 32 to 500 g/mol, preferably from 60 to 300 g/mol, which contain at least two amino groups selected from the group consisting of primary and secondary amino groups. Examples of such amines are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane.

The amines can also be used in blocked form, e.g., in the form of the corresponding ketimines (see for example CA-A 1 129 128), ketazines (cf. e.g. U.S. Pat. No. 4,269,748) or amine salts (see U.S. Pat. No. 4,292,226). Oxazolidines as well, as used for example in U.S. Pat. No. 4,192,937, represent blocked polyamines which can be used for the preparation of the polyurethanes of the invention, for chain extension of the prepolymers. Where blocked polyamines of this kind are used they are generally mixed with the prepolymers in the absence of water and this mixture is then mixed with the dispersion water or with a portion of the dispersion water, so that the corresponding polyamines are liberated by hydrolysis.

It is preferred to use mixtures of diamines and triamines, more preferably mixtures of isophoronediamine (IPDA) and diethylenetriamine (DETA).

The polyurethanes comprise preferably from 1 to 30 mol %, more preferably from 4 to 25 mol %, based on the total amount of components (b) and (d), of a polyamine having at least 2 isocyanate-reactive amino groups as monomer (d).

For the same purpose it is also possible to use, as monomers (d), isocyanates having a functionality of more than two. Examples of standard commercial compounds are the isocyanurate or the biuret of hexamethylene diisocyanate.

Monomers (e), which are used if appropriate, are monoisocyanates, monoalcohols, and mono-primary and -secondary amines. Their fraction is generally not more than 10 mol %, based on the total molar amount of the monomers. These monofunctional compounds customarily carry further functional groups such as olefinic groups or carbonyl groups and serve to introduce into the polyurethane functional groups which facilitate the dispersing and/or the crosslinking or further polymer-analogous reaction of the polyurethane. Monomers suitable for this purpose include those such as isopropenyl-a,a-dimethylbenzyl isocyanate (TMI) and esters of acrylic or methacrylic acid such as hydroxyethyl acrylate or hydroxyethyl methacrylate.

Within the field of polyurethane chemistry it is general knowledge how the molecular weight of polyurethanes can be adjusted by selecting the proportions of the mutually reactive monomers and also the arithmetic mean of the number of reactive functional groups per molecule.

Components (a) to (e) and their respective molar amounts are normally chosen so that the ratio A:B, where
A is the molar amount of isocyanate groups and
B is the sum of the molar amount of the hydroxyl groups and the molar amount of the functional groups which are able to react with isocyanates in an addition reaction,
   is from 0.5:1 to 2:1, preferably from 0.8:1 to 1.5, more preferably from 0.9:1 to 1.2:1. With very particular preference the ratio A:B is as close as possible to 1:1.

The monomers (a) to (e) employed carry on average usually from 1.5 to 2.5, preferably from 1.9 to 2.1, more preferably 2.0 isocyanate groups and/or functional groups which are able to react with isocyanates in an addition reaction.

The polyaddition of components (a) to (e) for preparing the polyurethane preferably takes place at reaction temperatures of up to 180° C., preferably up to 150° C., under atmospheric pressure or under the autogenous pressure.

The preparation of polyurethanes, and of aqueous polyurethane dispersions, is known to the skilled worker.

### The Further Constitutes of the PU Layer

Besides the heat-activatable polyurethane or polyurethanes the PU layer may comprise further constituents.

Besides the heat-activatable polyurethane, the PU layer may comprise further polymers as binders.

The further polymer may in particular be a polymer obtainable by free-radical addition polymerization of ethylenically unsaturated compounds (monomers).

The polymer is composed preferably of at least 40%, more preferably at least 60%, very preferably at least 80%, by weight of what are called principal monomers.

The principal monomers are selected from C1-C20 alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, or mixtures of these monomers.

Examples include (meth)acrylic acid alkyl esters having a C1-C10 alkyl radical, such as methyl methacrylate, methyl acrylate, n-butyl acrylate, ethyl acrylate, and 2-ethylhexyl acrylate.

Also suitable in particular are mixtures of the (meth)acrylic alkyl esters.

Vinyl esters of carboxylic acids having 1 to 20 C atoms are, for example, vinyl laurate, vinyl stearate, vinyl propionate, Versatic acid vinyl esters, and vinyl acetate.

Suitable vinylaromatic compounds include vinyltoluene, a- and p-methylstyrene, a-butylstyrene, 4-n-butylstyrene, 4-n-decylstyrene, and, preferably styrene. Examples of nitriles are acrylonitrile and methacrylonitrile.

The vinyl halides are chlorine-, fluorine- or bromine-substituted ethylenically unsaturated compounds, preferably vinyl chloride and vinylidene chloride.

Examples of vinyl ethers include vinyl methyl ether and vinyl isobutyl ether. Preference is given to vinyl ethers of alcohols comprising 1 to 4 C atoms.

As hydrocarbons having 2 to 8 C atoms and one or two olefinic double bonds mention may be made of ethylene, propylene, butadiene, isoprene, and chloroprene.

Preferred principal monomers are the C1 to C10 alkyl acrylates and methacrylates, especially C1 to C8 alkyl acrylates and methacrylates, and vinylaromatics, especially styrene, and mixtures thereof.

Very particular preference is given to methyl acrylate, methyl methacrylate, ethyl acrylate, n-butyl acrylate, n-hexyl acrylate, octyl acrylate, and 2-etyhlhexyl acrylate, styrene, and mixtures of these monomers.

Besides the principal monomers the monomer may comprise further monomers, examples being monomers containing carboxylic acid, sulfonic acid or phosphonic acid groups. Carboxylic acid groups are preferred. Examples that may be mentioned include acrylic acid, methacrylic acid, itaconic acid, maleic acid, and fumaric acid.

Further monomers are for example also monomers comprising hydroxyl groups, especially C1-C10 hydroxyalkyl (meth)acrylates and (meth)acrylamide.

As further monomers mention may additionally be made of phenyloxyethyl glycol mono(meth)acrylate, glycidyl acrylate, glycidyl methacrylate, and amino (meth)acrylates such as 2-aminoethyl (meth)acrylate.

As further monomers mention may also be made of crosslinking monomers.

Preferred polymers are composed of at least 40%, in particular at least 60%, and very preferably at least 80% by weight of C1-C20, especially C1-C10, alkyl (meth)acrylates, or of vinyl esters, in particular vinyl acetate, or mixtures of vinyl esters, in particular vinyl acetate, with ethylene.

Preferred polymers which are used if appropriate in a mixture with the heat-activatable polyurethane in the PU layer are therefore polyacrylates, polyvinyl acetate or ethylene/vinyl acetate copolymers, or other polyurethanes which are not heat-activatable.

In one preferred embodiment the polymers are prepared by emulsion polymerization and the product is therefore an emulsion polymer.

The preparation may alternatively take place for example by solution polymerization with subsequent dispersion in water.

The PU layer is composed in all of at least 30%, preferably at least 40%, more preferably at least 50%, in particular at least 70%, or at least 90%, by weight of heat-activatable polyurethane, based on the sum of all the constituents.

In one particular embodiment, the PU layer comprises, besides the polyurethane, no further polymer as binder.

The further constituents of the PU layer may in particular be crosslinkers.

Preferably the PU layer comprises at least one crosslinker for the polyurethane.

Particularly suitable crosslinkers include chemically blocked isocyanates, compounds comprising silane groups, especially encapsulated compounds comprising silane groups, encapsulated isocyanates, encapsulated uretdiones, biuretes or allophanates or, with particular preference, compounds containing carbodiimide groups.

The crosslinker may be attached to the polyurethane, and in that case the polyurethane is self-crosslinking, or else the crosslinker may be a compound which is dissolved or distributed in the polyurethane.

With preference the PU layer comprises 0.0001 to 0.1 mol, preferably 0.0005 to 0.1 mol, more preferably 0.001 to 0.1 mol of carbodiimide groups to 100 g of polyurethane. In particular the amount of carbodiimide groups is not greater than 0.05 mol/100 g of polyurethane.

Carbodiimide groups have the general structural formula —N═C═N—.

Suitable compounds containing carbodiimide groups (carbodiimides for short) comprise in general on average 1 to 20, preferably 1 to 15, more preferably 2 to 10, carbodiimide groups.

The number-average molar weight Mn of the carbodiimides is preferably 100 to 10 000, more preferably 200 to 5000, and very particularly 500 to 2000 g/mol.

The number-average molecular weight is determined by endgroup analysis of the diisocyanates (i.e., consumption of the isocyanate groups by carbodiimide formation, see below) or, if endgroup analysis is not possible, by gel permeation chromatography (polystyrene standard, THF as eluent).

Carbodiimide groups are obtainable in a simple way from two isocyanate groups, with elimination of carbon dioxide:

—R—N═C═O+O═C═N—R

—R—N═C═N—R—+CO₂

Starting from polyisocyanates or diisocyanates it is possible in this way to obtain carbodiimides containing two or more carbodiimide groups and, if appropriate, isocyanate groups, especially terminal isocyanate groups.

Examples of suitable diisocyanates include diisocyanates X(NCO)2, where X is an aliphatic hydrocarbon radical having 4 to 12 carbon atoms, a cycloaliphatic or aromatic hydrocarbon radical having 6 to 15 carbon atoms, or an araliphatic hydrocarbon radical having 7 to 15 carbon atoms. Examples of such diisocyanates include tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)-propane, trimethylhexane diisocyanate, 1,4-diisocyanatobenzene, 2,4-diisocyanatotoluene, 2,6-diisocyanatotoluene, 4,4′-diisocyanato-diphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis, and the cis/trans isomers, and mixtures of these compounds.

Particular preference is given to TMXDI.

As a result of the terminal isocyanate groups the carbodiimide can easily be hydrophilically modified, by reaction with amino acids or hydroxy acids, for example. Hydrophilically modified carbodiimides are of course easier to mix with aqueous adhesives or adhesives based on hydrophilic polymers.

With similar ease it is possible to attach the carbodiimides to the polymers, by reacting the isocyanate group with a reactive group of the polymer, such as an amino group or hydroxyl group.

The PU layer may therefore comprise the carbodiimides as, for example, an additive or in bound form, as a result for example of attachment to a polyurethane or to a free-radically polymerized polymer.

The PU layer comprises preferably further reactive groups which are able to enter with one another or with the carbodiimide groups into a crosslinking reaction.

Suitable groups include carboxyl or carboxylate groups for example. These reactive groups are present preferably in an amount of 0.0001 to 0.5 mol, more preferably of 0.0005 to 0.5 mol/100 g of polyurethane.

Carboxyl groups are also formed by transesterification reactions, so that crosslinking occurs even without the initial presence of carboxyl groups in the polyurethane.

The PU layer may comprise further additives, such as wetting agents, defoamers, film-forming assistants, thickeners, thixotropic agents (e.g., pyrogenic silicas) or plasticizers or other auxiliaries.

### The Film as a Whole

The film of the invention may in one preferred embodiment be composed solely of the PU layer. In this case the PU layer must have a sufficient thickness that self-supporting films with tensile strength are formed. To produce the film the polyurethane can be filmed in a known way, together if appropriate with further binders or auxiliaries. For this purpose it is possible to start from aqueous polyurethanes, to stir in the further binders and adjuvants, to knife-coat the aqueous composition onto a substrate provided with a nonstick coating (silicone paper or silicone-coated film), and to carry out drying. The resulting film is self-supporting and can be removed from the substrate.

The film of the invention may also be of multilayer construction. In particular the film may be composed of two PU layers with a carrier layer in between. The PU layers are on the outside and in use bond in each case to one of the two substrates, so that the substrates to be bonded adhere to one another in turn by way of the film.

Suitable carrier films are any desired films, examples being textile carriers, such as woven textile fabrics, or leather; polymer films are preferred.

In any of the above embodiments the film of the invention can if appropriate be coated on one or both sides with an adhesive, as for example with a customary pressure-sensitive adhesive, including with a pressure-sensitive polyurethane adhesive.

It is also possible for the film of the invention to be lined on one side or even if appropriate on both sides with a (removable) release liner, i.e., nonstick layer, e.g., a siliconized paper or a siliconized film. The release liner is peeled off prior to use.

The coating with a pressure-sensitive adhesive has the advantage that in the course of its subsequent use the film has an initial adhesion even before the polyurethane is heat-activated, and can be fixed in a desired position.

On heat-activation, the polyurethane melts and becomes mixed with the pressure-sensitive adhesive, so that in this case as well the substrates are joined via the polyurethane.

An adhesive coating is not, however, absolutely necessary for the purposes of the present invention.

The thickness of the film is in particular 1 μm to 3 mm, more preferably 10 μm to 500 μm, very preferably 10 μm to 200 μm, and in one particularly preferred embodiment 30 μm to 80 μm.

The film preferably has a tensile strength (at 21° C.)>0.3 N/mm², preferably >1 N/mm², more preferably >10 N/mm².

The film is heat-activatable. By heat-activatability is meant the property whereby the film at 20° C. is blocking-resistant, i.e., non-tacky. Only when heated to higher temperatures, particularly temperatures above the melting point, does the film become tacky, i.e., the polyurethane melts and acts as an adhesive.

### The Use

The film of the invention is used in particular as an adhesive, with particular preference as a laminating adhesive. The film can be used as an adhesive for any desired substrates, including for example textiles, footwear soles, etc.

Laminating adhesives join substrates of large surface area to one another—for example, join laminates to other laminates, or laminates to moldings.

By laminate is meant any desired substrate of large surface area having a thickness of less than 10 mm, in particular less than 5 mm, more preferably less than 0.5 mm, and with very particular preference less than 3 mm.

The laminates in question may in particular be polymer films, metal foils, nonwoven webs of synthetic or natural fibers, coated or uncoated paper, or else veneers of real or imitation wood.

Particular preference is given to polymer films, e.g., films of polyester, such as polyethylene terephthalate, polyolefins such as polyethylene, polypropylene or polyvinyl chloride, of polyacetate, or else polyurethane films (comprising non-heat-activatable polyurethane).

The molding may be any desired molding, such an automotive interior component, such as dashboard, inner door lining or parcel shelf, or a piece or component of furniture. The molding may in particular be of wood or plastic, e.g., ABS (acrylonitrile-butadiene-styrene). It may for example be solid wood or plywood.

The moldings in question may in particular be composed of synthetic or natural fibers or chips which are consolidated by means of a binder to form a molding.

The film of the invention is used preferably for laminating moldings to any desired laminates,
a) the film and the laminate being deposited on the molding, so that the film is located between the molding and the laminate,
b) the film being heat-activated, by means of infrared radiation for example, and
c) the molding being adhesively bonded to the laminate.

### Re a)

The film and the laminate to be laminated can be prepared separately and cut to size. The film may also be cut to size (laser cutting) before adhesive bonding, deformed or punched.

Film and laminate can also be assembled to form a composite prior to adhesive bonding. What is important is that the film of the invention is positioned with respect to the molding so that it is located between the laminate and the molding.

Alternatively the film can be placed together beforehand with the molding, or the film itself can be adapted or adhered to the molding. In that case the laminate is supplied at any later point in time and deposited on the film.

### Re b)

The heat activation can take place for example by means of IR radiation or microwave radiation. If appropriate it is also possible for the molding to be heated accordingly, in which case the heat is transferred, on contact, to the film.

The film of the invention is preferably heated to temperatures above the melting point of the polyurethane (see above), with particular preference to temperatures of 40 to 150° C. The temperature in the film of the invention is preferably 20 to 200° C., more preferably 30 to 180° C., and in particular 40 to 150° C.

### Re c)

Adhesive bonding takes place preferably under pressure, for which purpose it is possible to compress the parts to be bonded under a pressure of 0.05 to 5 N/mm2.

Alternatively the adhesive bonding can be carried out under reduced pressure (vacuum) in a thermoforming operation.

At the same time as adhesive bonding, the laminate to be bonded is brought if appropriate into the desired shape, so that it is adapted to the shape of the moldings. The above method can in particular also be carried out continuously; for that purpose it is possible in step a) of the method to unwind the film and the laminate continuously from a stock roll, to guide them together if appropriate, and, if appropriate, to cut them to size in a continuous operation, or to prepare them in some other way and then deposit them on the molding and carry out adhesive bonding.

The above method can also take place in two worksteps. In the first workstep the film of the invention is applied to one of the substrates to be bonded, by means for example of a heated roller or plate. In the second workstep, which may take place immediately thereafter or else at a very much later point in time (film is stable on storage), the adhesive bonding and/or lamination to the second substrate are/is carried out by heat activation of the polyurethane.

The method of the invention is a simple method of adhesively bonding substrates to one another, in particular of laminating moldings to laminates; the keeping of different films in stock can be reduced, since the adhesive, in the form of the film of the invention, can be used in any desired way. The prior coating and storage of different films is no longer necessary.

The products obtained have a high strength and good mechanical properties.

### EXAMPLES

Films 50 μm thick were produced. The films were obtained by filming the following mixtures (parts by weight ppw as-is, i.e., with water):

| | |
|---|---|
| Example A: | 200 ppw Luphen ® D DS 3585 X, a polyester-based |
| | polyurethane |
| Example B: | 150 ppw Luphen D DS 3585 X/50 ppw Acronal DS 3502, |
| | a polyacrylate dispersion |
| Example C: | 150 ppw Luphen D DS 3585 X/50 ppw Airflex EP 17, |
| | an ethylene/vinyl acetate copolymer |
| Example D: | 200 ppw Luphen D DS 3585 X/7 ppw Basonat DS 3582 |
| | (a carbodiimide crosslinker) |
| Example E: | 150 ppw Luphen D DS 3585 X/50 ppw Acronal DS 3502/ |
| | 5 ppw Basonat DS 3582 |
| Example F: | 150 ppw Luphen D DS 3585 X/50 ppw Airflex EP 17/5 |
| | ppw Basonat DS 3582 |

Using these carrier-free polyurethane films, composites were produced from a MDF board with a PVC laminating film, the PU films of the invention being placed on the MDF boards, and the PVC films atop them, in a commercially customary laminating press and then lamination being carried out at 95° C. (temperature of the upper press plate) for 45 seconds.

In order to investigate the quality of the adhesive bonds obtained, the cooled laminates were tested in the ascending heat test. For this purpose the MDF/PVC laminates are placed vertically in a heating cabinet, a 1 kg weight is hung onto the top free end of the PVC film in such a way as to produce a 180° C. angle, and then the oven is heated up in 30 min/5° C. steps. An assessment is made of the extent to which the PVC film parts from the MDF board (i.e., the travel distance) under the weight and under the increasing thermal load. The temperature reported is that at which the travel distance is not more than 20 mm.

| | |
|---|---|
| Example A: | 40° C. |
| Example B: | 50° C. |
| Example C: | 60° C. |
| Example D: | 55° C. |
| Example E: | 55° C. |
| Example F: | 75° C. |

In all cases a true adhesive bond of the PVC film to the MDF board was obtained. The positive effect of the carbodiimide crosslinking is apparent.

In addition, unplasticized PVC films of the kind used for laminating in the interior fitment of automobiles were bonded to ABS test specimens. ABS is a typical plastic for the production of door side parts. The activation temperature in a flat press was approximately 80° C. The laminating pressure was 0.5 bar. The press time was 1 minute. The ABS test specimens were preconditioned at a temperature of approximately 70° C., the film of the invention was placed between ABS and the unplasticized PVC film, and then pressing was carried out under the press conditions specified above.

In the corresponding peel test, carried out with a peel angle of the unplasticized PVC film of 90, and at 90° C., we obtained the following values:

| | |
|---|---|
| Example D: | 15 N/5 cm |
| Example E: | 18 N/5 cm |
| Example F: | 21 N/5 cm |

These values are within the range also achieved by laminating adhesives which have been customary to date.

1. The use of a film for adhesively bonding two substrates, wherein the film comprises a layer which is composed of more than 30% by weight of a heat-activatable polyurethane (PU layer for short).

2. The use according to claim 1, wherein the polyurethane is synthesized from more than 60% by weight of synthesis components selected from diisocyanates, polyesterdiols, polyetherdiols or mixtures thereof.

3. The use according to claim 1, wherein the polyurethane is synthesized from more than 10% by weight of polyesterdiols.

4. The use according to claim 1, wherein the polyurethane has a melting point in the range from 30 to 150° C.

5. The use according to claim 1, wherein the PU layer comprises a crosslinker for the polyurethane.

6. The use according to claim 1, wherein the PU layer comprises 0.0001 to 0.1 mol of carbodiimide groups to 100 g of polyurethane.

7. The use according to claim 1, wherein the PU layer besides the polyurethane comprises if appropriate further polymeric binders, examples being polymers obtainable by free-radical addition polymerization, and auxiliaries, examples being wetting agents.

8. The use according to claim 1, wherein the film is composed of the PU layer and the PU layer is coated if appropriate on one or both sides with a pressure-sensitive adhesive or primer or both.

9. The use according to claim 1, wherein the film is composed of two PU layers with a carrier layer in between, and the outside PU layers are coated if appropriate with pressure-sensitive adhesive or with a primer.

10. The use according to claim 1, wherein the thickness of the film is 1 μm to 3 mm.

11. The use according to claim 1, wherein the film is used as a laminating adhesive.

12. A method of laminating moldings to any desired laminates, which comprises
a) depositing on the molding a film according to claim 1 and a laminate to be laminated on, so that the film is located between the molding and the laminate,
b) heat-activating the film, by means of infrared radiation for example, and
c) adhesively bonding the molding to the laminate.

13. The method according to claim 12, which is carried out continuously.

14. The method according to claim 12, which is carried out under reduced pressure, in a thermoforming operation for example, or under elevated pressure.

15. A product, in particular a laminated molding, obtainable through use according to claim 1.

16. A film composed of a PU layer according to claim 1, the PU layer being coated if appropriate on one or both sides with a pressure-sensitive adhesive or primer or both.

17. A film composed of two PU layers according to claim 1 and of a carrier layer in between, the outside PU layers being coated if appropriate with pressure-sensitive adhesive or with a primer or with both.

18. A product, in particular a laminated molding, obtainable through the method according to claim 12.
